(19) United States
(12) Patent Application Publication
(10) Pub. No.: US 2014/0119356 A1
(43) Pub. Date: May 1, 2014

(54) NFC SERVER AND NFC SERVICE METHOD OF COMMUNICATION DEVICES USING WIFI DIRECT

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventor: HUNG-CHI HUANG, New Taipei (TW)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/022,257

(22) Filed: Sep. 10, 2013

(30) Foreign Application Priority Data
Oct. 31, 2012 (TW) 101140229

(51) Int. Cl. H04W 76/02

(52) U.S. Cl. CPC H04W 76/023
USPC 370/338

(57) ABSTRACT

In a near-field communication (NFC) service method of communication devices using WIFI Direct, each of the communication devices connects to an NFC server through a wireless network. Information of the communication devices is registered to the NFC server, and a service authorization of each of the communication devices is set according to an NFC service rule. A member register list is generated according to the service authorizations of the communication devices. When the communication device has been registered in the member register list, the communication devices are grouped into the communication group according to the service authorizations of the communication devices, so as to accomplish device authorization of the communication devices in the NFC server. A WIFI Direct connection is then established between any two of the communication devices in the communication group to perform a WIFI service for each of the communication devices.

### BACKGROUND

1. Technical Field

Embodiments of the present disclosure relate to near-field communication (NFC) service systems and methods, and particularly to an NFC server and an NFC service method of communication devices using WIFI Direct.

2. Description of Related Art

Portable communication devices, such as cell phones, laptops, and tablets, have become increasingly common as their costs have come down and their functionalities have increased. Many mobile devices support wireless standards, such as NFC, WIFI, and WIFI Direct. NFC is a short-range wireless technology used to share or transfer data, such as files, audio and video data, and application, etc. WIFI Direct is a new standard from the WIFI alliance that has a maximum range of over 200 meters, and allows a mobile device to establish a Peer-to-Peer (P2P) connection with another mobile device without using an access point.

However, there is no combination of WIFI Direct and NFC services to pair and authorize different mobile devices. In addition, it is a problem to implement some NFC functions, such as encrypting data while transferring data, and establishing chat services between the different mobile devices. Therefore, there is room for improvement in the art.

### BRIEF DESCRIPTION OF THE DRAWINGS

FIG. 1 is a block diagram of one embodiment of an NFC server including an NFC service system.

FIG. 2 is a flowchart of one embodiment of an NFC service method of communication devices using WIFI Direct.

FIG. 3 illustrates one exemplary embodiment of a position distribution of the communication devices in a communication group.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

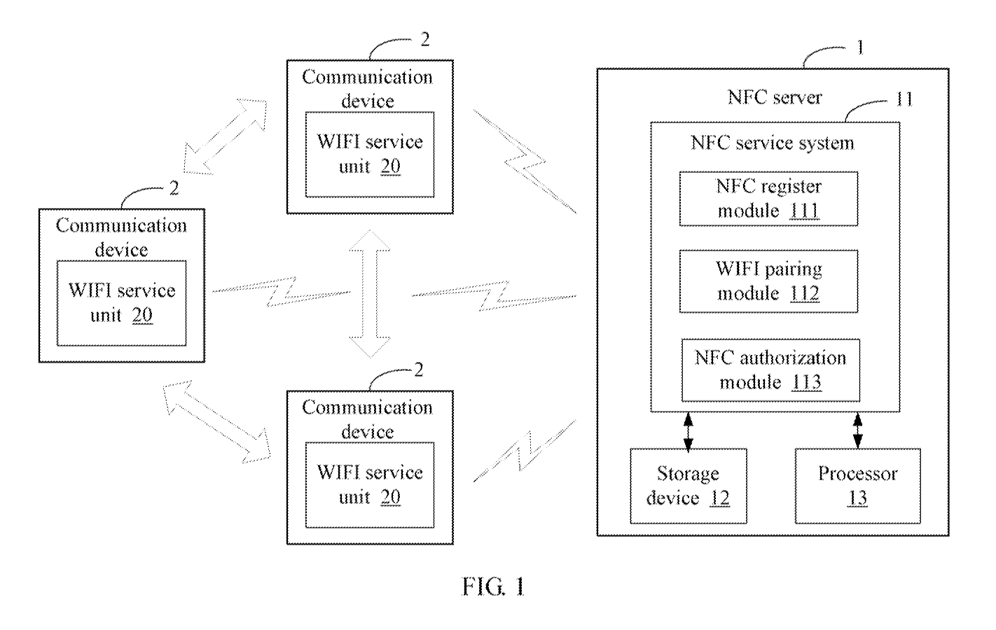

FIG. 1 is a block diagram of one embodiment of a near-field communication (NFC) server 1 including an NFC service system 11. In the embodiment, the NFC service system 11 is implemented by the NFC server 1. The NFC server 1 uses NFC and WIFI Direct to implement various WIFI services, such as data transmission, data access, chat service, data synchronization, and data encryption. The NFC server 1 connects to a plurality of communication devices 2 through a wireless network, such as a 3G network, a 4G network, a WIFI network, or a GSM (Global System for Mobile Communications) network. Each of the communication devices 2 also communicates with each other through the wireless network.

The NFC server 1 further includes, but is not limited to, a storage device 12 and at least one processor 13. The NFC server 1 is a wireless communication device having an NFC service function, and communicates with the communication devices 2 through the wireless network. In one embodiment, each of the communication devices 2 can be a mobile phone, a Personal Digital Assistant (PDA), a laptop, a tablet, or any other mobile communication device having the WIFI Direct function.

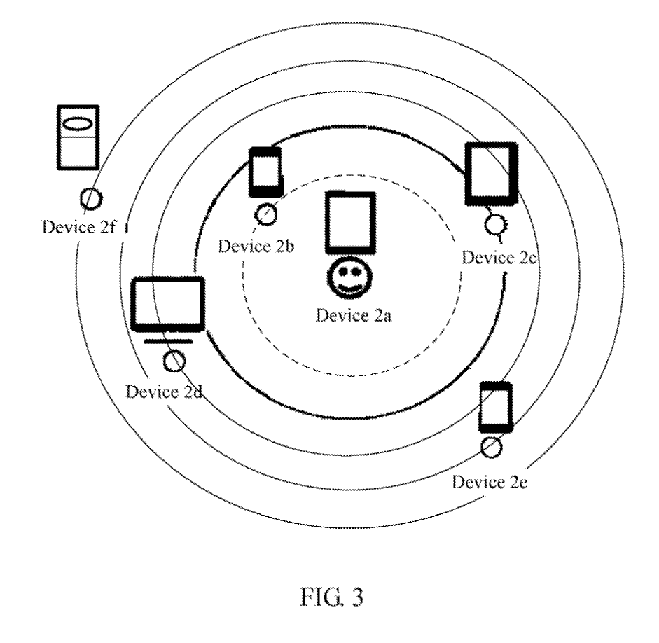

Each of the communication devices 2 includes a WIFI service unit 20, which a position of each of the communication devices 2 located in a communication group according to a signal strength of each of the communication devices 2. FIG. 3 illustrates one exemplary embodiment of a position distribution of the communication devices 2 in the communication group. If a user selects a communication device 2 from the communication group as a local device 2a, the WIFI service unit 20 of the local device 2a establishes a Peer-to-Peer (P2P) connection between the local device 2a and another communication device 2 of the communication group, such as a device 2b. The WIFI service unit 20 of the local device 2a controls the local device 2a to communicate with the device 2b by using WIFI Direct.

In one embodiment, the storage device 12 may be an internal storage system, such as a random access memory (RAM) for temporary storage of information, and/or a read only memory (ROM) for permanent storage of information. The storage device 12 may also be an external storage system, such as an external hard disk, a storage card, network attached storage (NAS), a web database, or a data storage medium. The at least one processor 13 is a central processing unit (CPU) or microprocessor that performs various functions of the NFC server 1.

In one embodiment, the NFC service system 11 includes an NFC register module 111, a WIFI pairing module 112, and an NFC authorization module 113. The modules 111-113 may comprise computerized instructions in the form of one or more computer-readable programs that are stored in a non-transitory computer-readable medium (such as the storage device 12) and executed by the at least one processor 13. A description of each module is given in the following paragraphs.

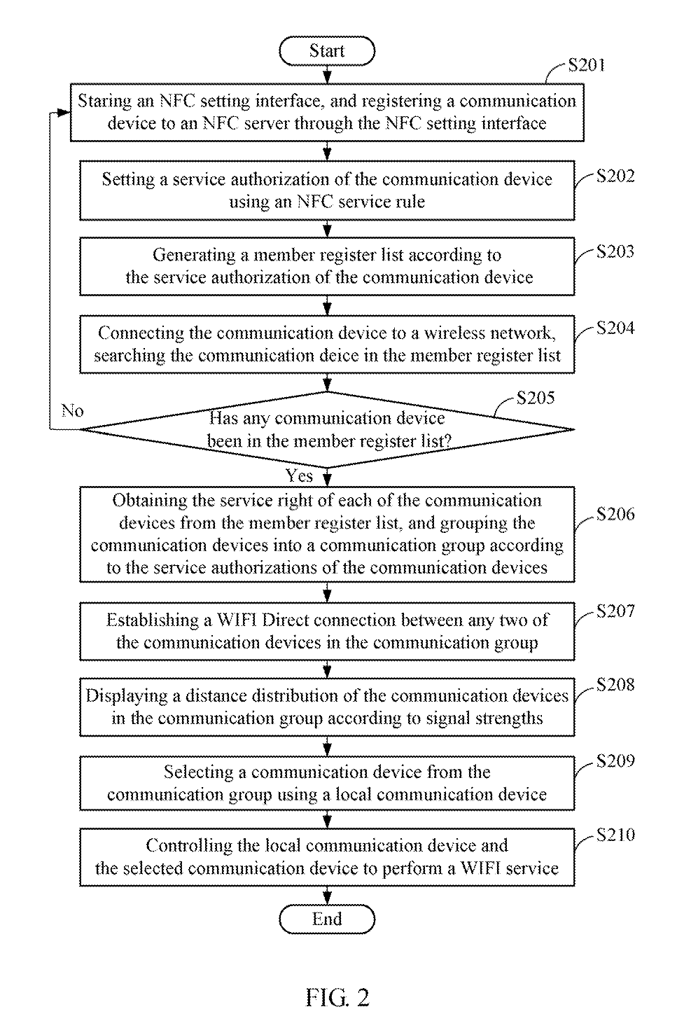

FIG. 2 is a flowchart of one embodiment of an NFC service method of the communication devices 2 using WIFI Direct. In the embodiment, the method uses NFC and WIFI Direct to implement various WIFI services, such as data transmission, data access, chat service, data synchronization, and data encryption. Depending on the embodiment, additional steps may be added, others removed, and the ordering of the steps may be changed.

In step S201, the NFC register module 111 invokes an NFC setting interface of the NFC server 1, and registers information of a communication device 2 to the NFC server 1 through the NFC setting interface. In the embodiment, the information of the communication device 2 can include a device name, an IP address, and a communication port of the communication device 2.

In step S202, the NFC register module 111 sets a service authorization for the communication device 2 according to an NFC service rule. In the embodiment, the NFC service rule includes, but is not limited to, a data transfer authorization, a chat authorization, a data access authorization, a data synchronization authorization, and a data encryption authorization.

In step S203, the NFC register module 111 generates a member register list according to the service authorization of the communication device 2, and stores the member register list in the storage device 12. In the embodiment, the member register list records a device name, an IP address, and the service authorization of each of the communication devices 2.

In step S204, the WIFI pairing module 112 connects the communication device 2 to the NFC server 1 through the wireless network, and searches for the communication device 2 in the member register list that have been connected to the NFC server 1.

In step S205, the WIFI pairing module 112 determines whether or not any of the communication devices 2 has been registered in the member register list. If each of the communication devices 2 has been registered in the member register list, step S206 is implemented. Otherwise, if there is a communication device 2 that has not been registered in the member register list, step S201 is repeated.

In step S206, the NFC authorization module 113 obtains the service authorization of each of the communication devices 2 from the member register list, and groups the communication devices 2 into the communication group according to the service authorizations of the communication devices 2, thereby completing authorization of each of the communication devices 2 in the NFC server 1.

In step S207, the NFC authorization module 113 establishes a WIFI Direct connection between any two of the communication devices 2 in the communication group to perform a WIFI service for each of the communication devices 2.

In step S208, the WIFI service unit 20 generates a position distribution of the communication devices 2 in the communication group according to a signal strength of each of the communication devices 2. Referring to FIG. 3, the position distribution of the communication devices 2 in the communication group is generated according to a signal strength of each of the communication devices 2. For example, device 2a, device 2b, device 2c, device 2d, device 2e, and device 2f are shown in the communication group.

In step S209, the user uses a local communication device 2 to select a communication device 2 from the communication group, and the WIFI service unit 20 establishes a WIFI direct connection between the local communication device 2 and the selected communication device 2. Referring to FIG. 3, if the user uses a device 2a to select a device 2b from the communication group, the WIFI service unit 20 of the local device 2a establishes a Peer-to-Peer (P2P) connection between the local device 2a and the selected device 2b in the communication group.

In step S210, the WIFI service unit 20 controls the local communication device 2 and the selected communication device 2 to perform various WIFI services, such as data transmission, data access, chat service, data synchronization, and data encryption. Referring to FIG. 3, the WIFI service unit 20 of the local device 2a controls the local device 2a to communicate with the selected device 2b to perform a WIFI service, such as a data transmission and a chat service.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A near-field communication (NFC) server being connected with a plurality of communication devices through a wireless network, the NFC server comprising:
at least one processor; and
a storage device storing one or more computer-readable programs including instructions that, which when executed by the at least one processor, causes the at least one processor to:
invoke an NFC setting interface of the NFC server, and register information of each of the communication devices to the NFC server through the NFC setting interface;
set a service authorization of each of the communication devices according to an NFC service rule;
generate a member register list according to the service authorizations of the communication devices, and store the member register list in the storage device;
connect the communication devices to the NFC server through the wireless network, and search the communication devices connected to the NFC server in the member register list;
obtain the service authorization of each of communication devices from the member register list when each of the communication devices has been registered in the member register list;
group the communication devices into a communication group according to the service authorizations of the communication devices; and
establish a WIFI Direct connection between any two of the communication devices in the communication group to perform a WIFI service for each of the communication devices.

2. The NFC server according to claim 1, wherein each of the communication devices comprises a WIFI service unit that displays a position of each of the communication devices located in the communication group according to a signal strength of each of the communication devices.

3. The NFC server according to claim 2, wherein the WIFI service unit establishes a Peer-to-Peer (P2P) connection between a first communication device and a second communication device in the communication group when the first communication device is selected from the communication group.

4. The NFC server according to claim 3, wherein the WIFI service unit controls the first communication device to communicate with the second communication device by performing a WIFI service comprising data transmission, data access, chat service, data synchronization, and data encryption.

5. The NFC server according to claim 1, wherein the NFC service rule comprises a data transfer authorization, a chat authorization, a data access authorization, a data synchronization authorization, and a data encryption authorization.

6. The NFC server according to claim 1, wherein the member register list records a device name of each of the communication devices, an IP address of each of the communication devices, and the service authorization of each of the communication devices.

7. A near-field communication (NFC) service method of communication devices using WIFI Direct, each of the communication devices being connected with an NFC server through a wireless network, the method comprising:
invoking an NFC setting interface of the NFC server, and registering information of each of the communication devices to the NFC server through the NFC setting interface;
setting a service authorization of each of the communication devices according to an NFC service rule;
generating a member register list according to the service authorizations of the communication devices, and storing the member register list in a storage device of the NFC server;
connecting the communication devices to the NFC server through the wireless network, and searching the communication devices connected to the NFC server in the member register list;
obtaining the service authorization of each of communication devices from the member register list when each of the communication devices has been registered in the member register list;
grouping the communication devices into a communication group according to the service authorizations of the communication devices; and
establishing a WIFI Direct connection between any two of the communication devices in the communication group to perform a WIFI service for each of the communication devices.

8. The method according to claim 7, wherein each of the communication devices comprises a WIFI service unit that displays a position of each of the communication devices located in the communication group according to a signal strength of each of the communication devices.

9. The method according to claim 8, wherein the WIFI service unit establishes a Peer-to-Peer (P2P) connection between a first communication device and a second communication device in the communication group when the first communication device is selected from the communication group.

10. The method according to claim 9, wherein the WIFI service unit controls the first communication device to communicate with the second communication device by performing a WIFI service comprising data transmission, data access, chat service, data synchronization, and data encryption.

11. The method according to claim 7, wherein the NFC service rule comprises a data transfer authorization, a chat authorization, a data access authorization, a data synchronization authorization, and a data encryption authorization.

12. The method according to claim 7, wherein the member register list records a device name of each of the communication devices, an IP address of each of the communication devices, and the service authorization of each of the communication devices.

13. A non-transitory storage medium having stored thereon instructions that, when executed by at least one processor of a near-field communication (NFC) server, cause the processor to perform an NFC service method of communication devices using WIFI Direct, the method comprising: invoking an NFC setting interface of the NFC server, and registering information of each of the communication devices to the NFC server through the NFC setting interface;
setting a service authorization of each of the communication devices according to an NFC service rule;
generating a member register list according to the service authorizations of the communication devices, and storing the member register list in a storage device of the NFC server;
connecting the communication devices to the NFC server through the wireless network, and searching the communication devices connected to the NFC server in the member register list;
obtaining the service authorization of each of communication devices from the member register list when each of the communication devices has been registered in the member register list;
grouping the communication devices into a communication group according to the service authorizations of the communication devices; and
establishing a WIFI Direct connection between any two of the communication devices in the communication group to perform a WIFI service for each of the communication devices.

14. The storage medium according to claim 13, wherein each of the communication devices comprises a WIFI service unit that displays a position of each of the communication devices located in the communication group according to a signal strength of each of the communication devices.

15. The storage medium according to claim 14, wherein the WIFI service unit establishes a Peer-to-Peer (P2P) connection between a first communication device and a second communication device in the communication group when the first communication device is selected from the communication group.

16. The storage medium according to claim 15, wherein the WIFI service unit controls the first communication device to communicate with the second communication device by performing a WIFI service comprising data transmission, data access, chat service, data synchronization, and data encryption.

17. The storage medium according to claim 13, wherein the NFC service rule comprises a data transfer authorization, a chat authorization, a data access authorization, a data synchronization authorization, and a data encryption authorization.

18. The storage medium according to claim 13, wherein the member register list records a device name of each of the communication devices, an IP address of each of the communication devices, and the service authorization of each of the communication devices.
